(19) United States
(12) Patent Application Publication
(10) Pub. No.: US 2012/0267565 A1
(43) Pub. Date: Oct. 25, 2012

(54) ROAD AND SOIL TREATMENT APPLICATIONS

(76) Inventor: Robert Gregory Kerr, Maddington (AU)

(21) Appl. No.: 13/516,695

(22) PCT Filed: Dec. 15, 2010
(86) PCT No.: PCT/AU2010/001688

§ 371 Date: Jun. 18, 2012

(30) Foreign Application Priority Data
Dec. 15, 2009 (AU) 2009906082

(51) Int. Cl. C09K 3/22

(52) U.S. Cl. 252/88.1

(57) ABSTRACT

A composition and method for stabilising an unsealed surface, the composition comprising hygroscopic material and one or more cationic or non-ionic emulsions.

### FIELD OF THE INVENTION

The present invention relates to road and soil treatment applications.

More particularly, the invention uses various hygroscopic compounds to significantly enhance the performance of pre-formed and newly-formed emulsions and compounds (binders) used as dust palliatives and particularly for the stabilising, sealing, compacting or adhesion of unsealed granular aggregate surfaces (various sands, gravels and native soils—either naturally occurring or manufactured) or as cementitious binders of granular aggregate bases.

### BACKGROUND ART

Magnesium chloride, calcium chloride and other hygroscopic compounds are known as dust suppressants and compaction agents for use on unsealed roads and tracks. These compounds are used either in solid or liquid form and work by drawing moisture from the surrounding environment, including the air, and causing soil particles to compact closer together than they otherwise would. One of the main drawbacks of these types of compounds is that they are readily soluble and hence can be washed out of the road surface during rain events.

There also exists a number of compounds and emulsions (binders) used for the stabilising, sealing or compacting of unsealed granular aggregate surfaces. Many of these are of water-based products, either as solutions or emulsions that require the evaporation of excess water after application in order to ‘set’ and bind the soil or gravel particles. These compounds include, but are not limited to, acrylic polymers, lignosulphonates, tall oil pitch emulsions, petroleum emulsions and various glues. There is a long history of the use of these types of binders with new ones appearing on the market every year. They are usually manufactured in liquid form or are hydrated on the jobsite through the addition of water. These binders can be used to improve the engineering properties of road gravels and aggregates such as bearing strength and cohesion prior to capping with a wearing surface. They can also be used as a surface treatment to reduce dust emission, gravel loss and to improve the driving or walking surface. One main drawback of these types of compounds is that they can set before the road surface is thoroughly compacted and subsequently fail to maintain their structural integrity.

It is known in the prior art that these binders, after being added to aggregate (various sands, gravels and native soils—either naturally occurring or manufactured) then begin to ‘break’ (in relation to emulsions) or ‘set’ (in relation to other compounds). This breaking or setting then causes a bond between the soil particles being treated. This can have the benefit of improving bearing strength, cohesion, adhesion, weather resistance and so on.

This ‘breaking’ or ‘setting’ usually takes place within a few hours after application, giving the practitioner a short window to achieve adequate compaction before the soil particles are fixed in place. Compaction is always critical to successful road building and is usually accomplished by the use of various steel-drummed or rubber-tyred rollers, which can be either static or vibratory. Compaction can also be achieved through normal traffic activity, but this is a slower process and the setting time of the binders usually does not allow it. Because most binders require either soaking in, or incorporation with the aggregate, the compacting effort cannot commence until after the binder is applied.

Because of the short window of time for compaction, considerable cost and difficulty is often experienced in obtaining adequate compaction. Expensive compaction equipment has to be onsite waiting for the binder to be applied and this equipment then only has time to compact a relatively small area before the binder begins to set or break. Attempting to compact the aggregate during the transition time of the binder from its aqueous form to a solid, final form will damage the bonding properties and is quite deleterious to the outcome trying to be achieved. Even if the compaction effort is ceased before the binder begins its transition, full compaction is not always obtained.

The effect of inadequate compaction is well known to road builders and engineers. The resulting weakness causes premature failing of the road or track through physical collapse, unravelling, subsidence and water ingress. It can be very difficult and expensive, if not impossible, to remediate after the fact—especially if a surface coating of bitumen, concrete or similar is then applied. Indeed, the presence of binders can hinder future compaction efforts.

Dust emission from unpaved roads is a significant expense. Dust palliatives are used extensively on these surfaces to reduce dust emission and surface erosion. A dust palliative is a compound applied to dust particles to coat individual particles and to bind such particles together to prevent them becoming airborne.

It is known in the prior art that roads, road shoulders, pathways and similar are often treated for dust emissions and surface erosion by the addition of either one of two broad categories of dust suppressants. The first category is the crusting agents, which includes the various binders mentioned above, and work by ‘gluing’ the soil particles together. The second category is comprised of the compaction agents and is usually one of the various hygroscopic compounds such as magnesium chloride or calcium chloride. The latter category works through moisture retention and ionic charge causing the aggregate particles to compact closer together than they otherwise would. Because the compaction agents do not attempt to resist the weight of the traffic, but instead use the weight of the traffic to achieve compaction, they are often preferable on high volume roads or roads heavy vehicles are present such as logging roads or mine sites. Many of these products, while laying the dust, may suffer from a tendency to form slick surfaces in the presence of clay and/or water, creating a potential hazard. Additionally, they may be leached out with rainfall.

There is a need for a dust palliative that provides a useful alternative to those already known in the industry. It would be advancement in the art to provide a dust palliative that provides both a high degree of stability for unpaved or unsealed surfaces, whilst overcoming the abovementioned problems associated with the prior art.

The preceding discussion of the prior art is intended to facilitate an understanding of the present invention only. It should be appreciated that the discussion is not an acknowledgement or admission that any of the material referred to was part of the common general knowledge in Australia and the world as at the priority date of the application.

Throughout the specification, unless the context requires otherwise, the word “comprise” or variations such as “comprises” or “comprising”, will be understood to imply the inclusion of a stated integer or group of integers but not the exclusion of any other integer or group of integers.

### DISCLOSURE OF THE INVENTION

In accordance with the present invention, there is provided a composition for stabilising an unsealed surface, the composition comprising hygroscopic material and one or more cationic or non-ionic emulsions.

Preferably, the hygroscopic material comprises one or more hygroscopic compounds. More preferably, the hygroscopic compounds are selected from the group magnesium chloride and calcium chloride.

Preferably, the cationic or non-ionic emulsion is selected from the group bituminous emulsions, latex emulsions, poly vinyl acetate (PVA) emulsions, pitch emulsions and co-polymer emulsions. More preferably, the said emulsion is selected from the group PVA emulsions, co-polymer emulsions and bituminous emulsions.

The cationic or non-ionic emulsion may be pre-formed or newly-formed but preferably is pre-formed.

The proportion of hygroscopic material to cationic or non-ionic emulsion may be in the range of 2% hygroscopic material to 98% emulsion up to a ratio of 98% hygroscopic material to 2% emulsion. More preferably, the proportion is in the range 85-90% hygroscopic material to 10-15% emulsion.

A preferred composition comprises 85-90% magnesium chloride to 10-15% cationic or non-ionic emulsion. A particularly preferred composition comprises 85-90% magnesium chloride to 10-15% PVA emulsion.

In accordance with another aspect of the present invention, there is provided a method for the provision of a stabilised unsealed surface, the method comprising the steps of blending a hygroscopic material with one or more cationic or non-ionic emulsions and applying the resultant mixture to a surface to be stabilised or sealed.

Preferably, the mixture is applied to the surface within 1-6 hours.

The components may be blended in a tanker or other suitable receptacle off site and transported to the surface to be stabilised or sealed.

The components may be combined on the surface to be stabilised and mixed in situ by means of a motor grader, rotary hoe, road stabiliser/scarifier or similar means. Alternatively, the components may be mixed with the aggregate in a pugmill or just applied as a topical surface treatment.

Preferably, the surface to be stabilised is mechanically rolled after application to create a suitable, well compacted surface.

### DETAILED DESCRIPTION OF THE INVENTION

Instructions for preparing the stabilising composition PolyMag™ ready for use. If the emulsion is viscous, slowly add the hygroscopic material (preferably in solution form) whilst circulating to ensure thorough mixing. Keep the resulting mixture away from extremes in temperature and only mix up enough for immediate use. If the emulsion is not viscous it is possible to add it to the hygroscopic solution slowly (preferably through a bottom feed point) whilst circulating the mixture until thoroughly mixed.

The PolyMag™ mixture can be applied via watercart with pressurized spraybar, cannon, fanspray or dribble bar or even by handheld hose. It can be applied directly as a topical application or incorporated through mixing with a motor grader or rotary mixer. Alternatively it can be mixed into the road materials beforehand by using a pugmill or similar mixing mechanism and the resulting PolyMag™-treated road material can then be laid onto the road surface in a timely manner and compacted before the PolyMag™ “cures”.

Instructions for the preferred method for applying PolyMag™ to a surface. The preferred method is to ensure the road has an adequate depth of suitable road material (ie the correct ratios of coarse and fine gravels, sands and clays) and then to pre-water then scarify the road surface to the depth desired. The PolyMag™ is then applied via a pressurized spraybar from a watercart then mixed into the road surface with a rotary mixer. The road surface would then be shaped by a motorgrader and thoroughly compacted with a mechanized roller. Traffic should then be allowed onto the surface to provide further compaction and when the optimal particle placement is achieved the PolyMag™ will then “set” and lock the road material into place. The hygroscopic component of the mixture serves to both enhance the compaction of the road surface and also delays the “setting” of the emulsion binder until optimal compaction is achieved. The emulsion binder component of the mixture locks the road particles into place once optimal compaction is achieved and adds water resistance to the hygroscopic component of the mixture.

1. A composition for stabilising an unsealed surface, the composition comprising hygroscopic material and one or more cationic or non-ionic emulsions.

2. A composition according to claim 1 comprising 85-90% magnesium chloride to 10-15% PVA emulsion.

3. A method for the provision of a stabilised unsealed surface, the method comprising the steps of blending a hygroscopic material with one or more cationic or non-ionic emulsions and applying the resultant mixture to a surface to be stabilised or sealed.

4. A composition for stabilising an unsealed surface, substantially as hereinbefore described.

5. A method for the provision of a stabilised unsealed surface, substantially as hereinbefore described.
